(19) United States
(12) Patent Application Publication
(10) Pub. No.: US 2008/0162813 A1
(43) Pub. Date: Jul. 3, 2008

(54) MULTIPLE LOGIC MEDIA DRIVE

(75) Inventors: Nils Haustein, Soergenloch (DE); Ulf Troppens, Mainz (DE); Josef Weingand, Bad Bayersoien (DE); Daniel J. Winarski, Tucson, AZ (US)

Correspondence Address: CANTOR COLBURN LLP - IBM TUSCON DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/619,037

(22) Filed: Jan. 2, 2007

(51) Int. Cl. G06F 12/00

(52) U.S. Cl. 711/115

(57) ABSTRACT

A system, apparatus, method, and computer product that allow multiple host systems to read and write, in parallel, to a single media and/or tape drive unit, without conflict.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to media and/or tape drive storage devices systems, and particularly to systems allowing multiple host systems to read and write, in parallel, to a single media and/or tape drive unit, without conflict.

2. Description of Background

Prior to the present invention, as shown in FIG. 1, prior art tape drives 101 consisted of one or two I/O interfaces 102 and 103 which usually offer one or two I/O addresses (Target IDs) to the host systems 130-132, a single buffer 104 which is used to cache data written to the tape drive via the I/O interface 102 and 103, a tape drive logic 105 incorporating microcode on appropriate logic cards controlling all operation of the tape drive. Host systems 130-132 are connected to the tape drive interfaces through a Storage Area Network (SAN 140). A tape library interface 115 allows connection to a tape library (not shown) where library specific commands are passed to a library hosting the tape drive 101. In terms of the mechanisms, read-write head 106 reads and writes data to the tape media 111, inboard-motor 108 spools the tape media 111, outboard motor 110 spools the tape media in the tape cartridge 113, and loader mechanism 112 loads the tape cartridge 113. Tape media 111 is spooled on a reel in tape cartridge 113 that is driven by motor 110. The tape drive logic 105 controls the operation of the tape drive. The host system 130 connects to the tape drives' I/O interfaces 102 and 103 via storage area network (SAN) 140. SAN 140 can be based on Fibre Channel, SCSI, iSCSI, iFCP, Gigabit Ethernet, and is not limited to these.

FIG. 4 shows an exemplary prior art tape cartridge 113. Tape cartridge 113 includes exterior cartridge shell 401 and sliding door 406. Sliding door 406 is slid open when tape cartridge 113 is inserted into drive 101 or 201 (FIG. 1 or 2). Sliding door 406 is normally closed when tape cartridge 113 is not in use, so that debris and contaminants do not enter tape cartridge 113 and degrade tape 111. The direction that tape cartridge 113 is slid into drive is shown as direction 107. Tape cartridge 113 also contains cartridge memory 403, which is on printed circuit board 405. Cartridge memory 403 is preferably at a 45 degree angle, to allow the drive, and users who choose to use an automated storage library (not shown), to access the contents of cartridge memory 403.

Tape reel 410 is stored in tape cartridge 113. Tape reel 410 is prevented from rotation when tape cartridge 113 is not in drive by brake button 412. The drive releases brake button 412 when tape cartridge 113 is inserted into drive, which then allows the free rotation of tape reel 410. Tape reel 410 is wound with tape 111. Tape 111 is preferably magnetic tape. However, tape 111 could equally be magneto-optical or optical phase-change tape or an equivalent medium. On the free end of tape 111 is an optional leader tape 420, and leader pin 415.

However, even though the prior art tape drive 101 offers two I/O interfaces 102 and 103, only one is active at a time. The second I/O interface is usually used for redundancy, i.e., if the first I/O interface is defective or the link to that interface is defective, or some infrastructure in the SAN 140 is defective, the second interface can be activated by the host system 130-132. Thus, both I/O interfaces share one and the same buffer 104 and tape drive logic 105 since only one interface is active at a time.

According to the prior art, multiple host systems or applications 130-132 can only perform I/O (i.e. read and write operations) to one tape drive in a sequential manner, even if the physical tape cartridge 113 includes multiple subcartridges as outlined in U.S. Pat. No. 6,067,481. Again, even though the tape drive has multiple interfaces 102, only one interface can be active at a time for one tape drive, for example, host system 131 can only use the tape drive when host system 130 is not using it, even though host system 130 uses just a part of the bandwidth which the tape drive can deliver.

Therefore, host system 131 has to wait until host system 130 is finished with I/O, even though the tape drive 101 could easily deliver more bandwidth. This sequential job/host processing causes longer backup times and requires additional investment for more tape drives.

In order to improve backup times by performing multiple parallel I/O, multiple tape drives 101 are required, which is more cost intensive than using a single tape drive.

Virtual tape libraries are also known wherein a separate appliance such as a virtual library with hard drives is located between the host computers and the physical tape drives in order to efficiently store or “premigrate” data before it is physically written or “migrated” to the physical tape to reduce wasted storage space on the tape and to improve speed of operation. However, virtual tape libraries systems are usually separate components from the physical tape drive itself, or are often too complex to be cost effective. Virtual Tape Libraries add a large disk cache and controller logic between the application server and the physical tape libraries. However, they do not allow parallel access to physical or virtual tape drives. In addition, virtual libraries are not based on physical tape drives and can exist without physical tape drives.

Such a prior art system is described in G. T. Kishi “The IBM Virtual Tape Server: Making Tape Controllers More Autonomic,” IBM Journal of Research & Development, Vol. 47, No. 4, July 2003 which is incorporated herein by reference. With reference to FIG. 5, in this prior art document, an application computer 10 hosts a user application 12, which maintains data that is regularly written on tape, and which is to be read sometimes from tape in order to be processed. A cache server 14 has a large hard disk capacity 18 that is controlled by a cache controller 16. The tape being used by the user application is emulated or virtualized by the cache controller 16. The actual data is written to disk cache 18. Thus, the application 12 writes data to “virtual tapes” (or logical volumes) residing in a disk cache 18. Logical volumes can be automatically being migrated to physical tape. The physical tapes used are one or more of the tapes 17 A to 17 M, which are managed in a tape library 19.

The above-mentioned prior art document discloses a storage subsystem that allows so called “volume stacking” wherein multiple logical volumes stored in the disk cache 18 are automatically migrated, i.e., written to one physical volume. In this prior art, the maximum capacity of a logical volume is a number of N times smaller than the capacity of a physical volume. N is in the range of several hundred.

The automation of migration is accomplished so that a logical volume once written by the user application is pre-migrated from disk-cache to physical volume (tape) immediately. Pre-migration means that there is a copy of the logical volume in disk cache 18 and on tape in tape library 19. The migration of the logical volume (logical volume resides on physical volume only and disappears from disk cache) is based on predetermined policies. These policies include usage (least recently used, LRU) and cache-preference groups. As long a logical volume resides in disk cache it is always accessed there allowing fast access compared to data retrieval times from a physical volume.

Data read operations to a logical volume, for example triggered by a mount operation in the user application, do not require any manual intervention, as they are done automatically. There are two major use cases. First, the logical volume is in disk cache 18, then the I/O operation is performed using the data in disk cache. The mount operation is very quick. Second, the logical volume has already been migrated to the physical volume and has been deleted from disk cache 18. Then, the entire logical volume is read from the physical volume (tape) to disk cache 18, and a subsequent I/O operation is performed using the data from disk cache.

The process of reading a logical volume from a physical volume is also referred to as recall. The recall operation is more time consuming and only tolerable when the capacity of logical volumes is small compared to the capacity of the physical volumes. In other words, this design is not appropriate when there is a 1:1 capacity relation between the logical volume and the physical volume, assuming that the capacity of a physical volume according to prior art can be 500 GB or more. With a 1:1 relation, recall times would exceed hours and the user application 12 will have to wait hours for the data request. In a typical environment, according to the prior art, the logical volume capacity is between 400 MB and 4 GB, whereas the physical volume capacities are at 500 GB.

U.S. Pat. No. 6,067,481 also discloses virtual multi-tape cartridges. In the preferred embodiment, a virtual multi-tape cartridge comprises of one or more so-called “subcartridges” where each subcartridge comprises of one or more longitudinal data tracks. Furthermore, each subcartridge can be divided into multiple distinct partitions. Furthermore, U.S. Pat. No. 6,067,481 introduces a virtual magnetic tape drive library system which is embedded into a single tape drive: All traditional mount, dismount, read, write, locate, and rewind commands are mapped to virtual multi-tape cartridges. Thus, a scratch mount request of an application can directly be served by a free subcartridge or subcartridge partition without needing time to move a physical tape cartridge from a slot of the physical tape library into a physical tape drive and loading the physical tape cartridge into the physical tape drive. However, the algorithms described in U.S. Pat. No. 6,067,481 indicate that the subcartridges or partitions of a subcartridge are used sequentially. U.S. Pat. No. 6,067,481 also does not introduce virtual tape drives.

Thus, an invention that describes how multiple virtual tape drives can work on multiple partitions of a cartridge or media in a “parallel” manner, and inclusive of the synchronization of conflicting I/O requests is needed. For example, U.S. Pat. No. 6,067,481 does not describe any mechanism to access multiple partitions in a parallel manner.

Also, an invention is needed so that multiple host computers can concurrently each use a separate virtual tape drive of the same physical tape drive while each application has only access to the data on its own partition without exposing their data to the other applications. U.S. Pat. No. 6,067,481 does not describe such a mechanism.

Thus, if the physical tape drive itself were improved to allow parallel access to multiple logical tape drives residing within one physical drive in a cost effective manner, it would also improve efficiency and reduce costs even if a virtual tape drive appliance is also used in the system.

### SUMMARY OF THE INVENTION

The shortcomings of the prior art are overcome and additional advantages are provided through the provision of a system that allows multiple host systems to read and write to a single media and/or tape drive unit without conflict in parallel.

An embodiment may comprise a single physical drive apparatus for use with removable-media partitioned into sections with multiple host computers making conflicting I/O requests comprising: a plurality of logical drives for the removable-media wherein each logical drive comprises: an I/O interface each having a unique device identifier; a virtual buffer associated uniquely with each device identifier; and an individual drive logic associated uniquely with each device identifier; the removable-media is structurally partitioned into sections wherein each partition is assigned to one of the plurality logical drives wherein each logical drive only may use a uniquely assigned partition on the removable-media according to the device identifier; a removable-media drive read and write head; a synchronized parallel central drive logic structured to manage and coordinate with each individual drive logic for reading, writing, and access to the removable-media partitioned into sections by the plurality of logical drives in parallel in order to synchronize and manage conflicting I/O requests, and providing buffer management based on a state of the logical media drives and an amount of virtual buffer allocated to the logical media drives wherein the central drive logic manages the assignment of the buffer to the appropriate logical media drive.

An embodiment may also comprise a method for controlling a physical removable-media drive apparatus with removable-media partitioned into sections and for use with multiple host computers comprising: reading or writing different sets of data in parallel to or from the multiple host computers to a plurality of logical media drives comprising: addressing a plurality of I/O interfaces each having a unique device identifier and located in the same physical tape drive, wherein each logical media drive: sends data through an I/O interface each having a unique device identifier; stores the data in a virtual buffer associated uniquely with each device identifier; and reads or writes the data via a media drive logic associated uniquely with each device identifier; assigning partitions in the removable-media partitioned into sections wherein each partition is assigned to one of the plurality logical removable-media drives so that each logical removable drive only may use a uniquely assigned partition on the removable-media partitioned into sections according to the device identifier; and reading or writing the data to the removable-media partitioned into sections in the uniquely assigned partition on the removable-media in parallel fashion according to the device identifier via a central drive logic structured to manage and coordinate with each of the media drive logics for reading, writing, accessing the removable-media in parallel by the plurality of logical media drives, and providing buffer management based on a state of the logical media drives and an amount of virtual buffer allocated to the logical media drives wherein the central drive logic manages the assignment of the buffer to the appropriate logical media drive.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution, method, apparatus, software, article of manufacture, and system which allows host systems 130-132 to perform multiple parallel I/O to one physical tape drive. This provides higher speed, savings in hardware resources, increased security of the system, better usability, simpler user interfaces, direct control of a physical device and its function and other benefits.

### BRIEF DESCRIPTION OF THE DRAWINGS

The subject matter of the invention is particularly pointed out and distinctly claimed in the claims at the conclusion of the specification. The foregoing and other objects, features, and advantages of the invention are apparent from the following detailed description taken in conjunction with the accompanying drawings which should not be interpreted to be limiting on the overall invention in any way, in which:

FIG. 1 illustrates one example of a prior art tape drive system.

FIG. 2 illustrates one example of an embodiment of the present tape drive system.

FIG. 3 illustrates one example of a partitioned tape of a tape drive according to prior art.

FIG. 4 illustrates a prior art tape and tape cartridge.

FIG. 5 illustrates a prior art virtual tape library system.

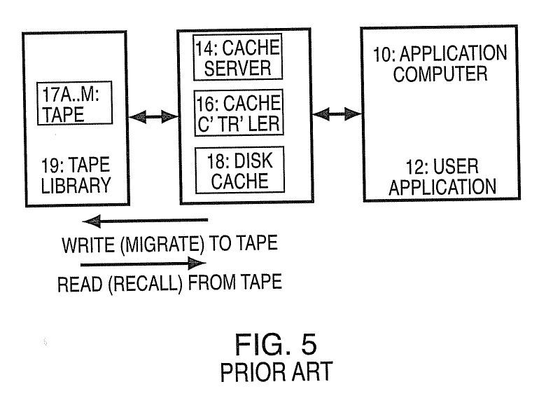

FIG. 6 illustrates an example SCSI move medium command that may be is extended for this invention.

FIG. 7 illustrates an example SCSI write command.

FIG. 8 illustrates an example SCSI read command.

The detailed description explains the preferred embodiments of the invention, together with advantages and features, by way of example with reference to the drawings.

### DETAILED DESCRIPTION OF THE INVENTION

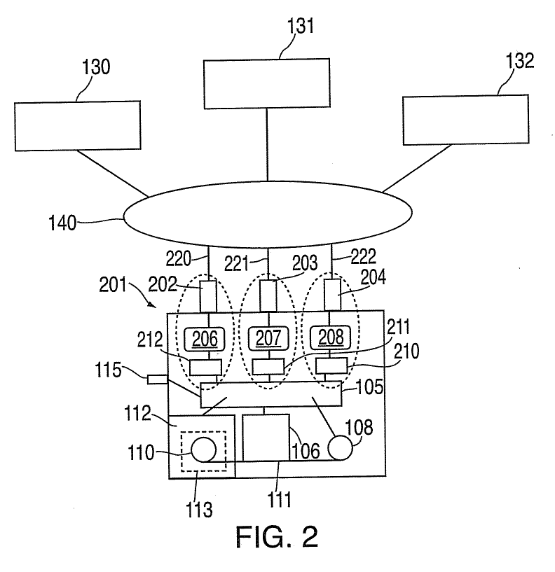

Turning now to the drawings in greater detail, it will be seen that in FIG. 2 that the present invention overcomes this “sequential” or “one at a time” I/O limitation by introducing a tape drive system and apparatus 201 comprising multiple I/O interfaces 202-204 per tape drive 201, each offering an I/O address(es) per I/O interface and a separate virtual buffer 206-208 and separated individual tape drive logics 210-212. Thus, the present invention may emulate several logical tape drives in one actual physical tape drive 201.

The I/O interfaces 202, 203, 204 can be physically the same, and the separate logical tape drives 220, 221, 222 can be addressed via different address identifiers (for example but not limited to: Logical Unit Number (LUN), SCSI Target ID, Fibre Channel World Wide Node Name WWNN of the server hosting the application, or World Wide Port Name WWPN of the I/O port which the application is communicating with, in conjunction with Node Port ID Virtualization (NPIV)) over one interface. The virtual buffer 206, 207, 208 can be physically the same memory, but managed for all logical tape drives by a central processor such as the tape drive controller 105. Each I/O interface offering an I/O address (or LUN) behaves like a logical tape drive 220-222. This eliminates the need for additional hardware for I/O interfaces and memory.

In summary, there are multiple logical tape drives 220, 221, 222 per physical tape drive 201. The number of logical tape drives per physical drive is typically more than two, but can be more than three. The three logical tape drives as shown in FIG. 2 are exemplary. In at least one embodiment, a logical tape 220 drive may comprise an I/O interface 202, an individual buffer 206 and individual tape drive logic 210 which controls all operation of the logical tape drive 220 and synchronizes the physical tape drives' operation with the other logical tape drives via the tape drive logic 105. The central tape drive logic 105 manages the assignment of the buffer 206, 207, 208 to the appropriate logical tape drive (220, 203, 204). There might also be one large buffer (not shown) where portions are dynamically assigned to the appropriate logical tape drive needing it. The central drive logic 105 also manages the access to the physical tape 111 from multiple logical tape drives (220, 203, 204).

Significantly, this system allows host systems 130-132 to perform multiple parallel I/O to one physical tape drive 201. For example, as shown in FIG. 2, one host system 130 can write to I/O interface 202 of logical tape drive 220, another host 131 can write to I/O interface 203 of logical tape drive 221 and yet another host 132 can read from I/O interface 204 of tape drive 222. Thus, by providing multiple logical tape drives (220, 221, 222) in one physical tape drive 201 including common components, such as tape drive logic 105, reel-motors 108, 110, loader 112 and read write head 106, contributes to tremendous cost and hardware savings, and improves bandwidth use and overall speed.

Each logical tape drive 220, 221, 222 is addressed by the host system(s) through a different address identifiers (for example but not limited to: Logical Unit Number (LUN), SCSI Target ID, Fibre Channel World Wide Node Name WWNN, or World Wide Port Name WWPN, in conjunction with Node Port ID Virtualization (NPIV)). Each logical tape drive may include an additional LUN according to the SCSI-3 medium changer architecture, i.e., each logical tape drive can include a LUN addressing the medium changer to perform mount and demount commands. Subsequently the term LUN is used to describe an I/O Interface and according I/O address. The I/O interfaces 202, 203, 204 of the logical tape drives can be physically the same and the separate logical drives can be addressed via different LUN's.

Each LUN (or logical tape drive 220, 221, 222) behaves like an individual tape drive having its interface 202, 203, 204 and its own buffer 206, 207, 208 and its own individual tape drive logic 210, 211, 212. The buffer for each logical drive 220, 221, 222 is large enough to facilitate I/O without data being written to tape. In an alternate embodiment, the buffer for each logical drive can also be shared between logical tape drives, i.e., there is one large buffer for the entire physical tape drive and the tape drive logic 105 assigns buffer to the appropriate logical drive in an on-demand fashion dynamically. Thus, if logical tape drive 220 performs write commands, the drive logic assigns more buffer to this logical tape drive than to tape drive 221 which is idle. Here buffer management logic would also be used, as described later. It is noted that a tape drive is used an example, but any media drive may substituted for a tape drive or where the term “tape” is used.

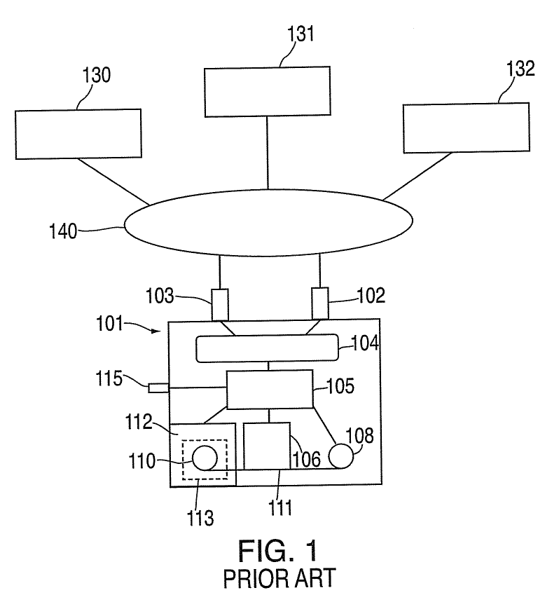

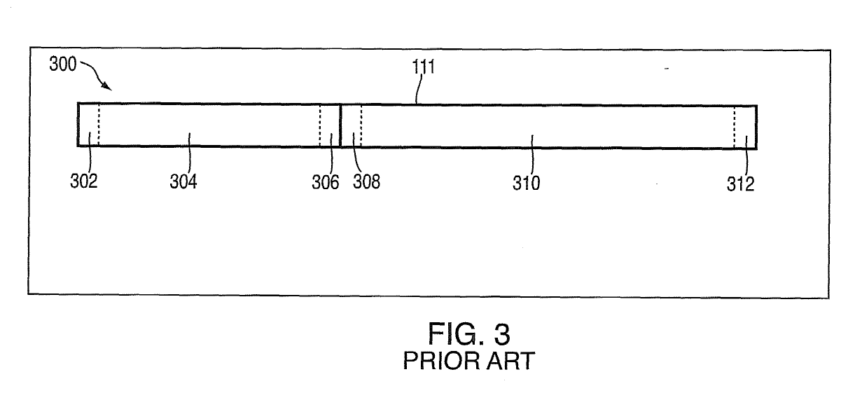

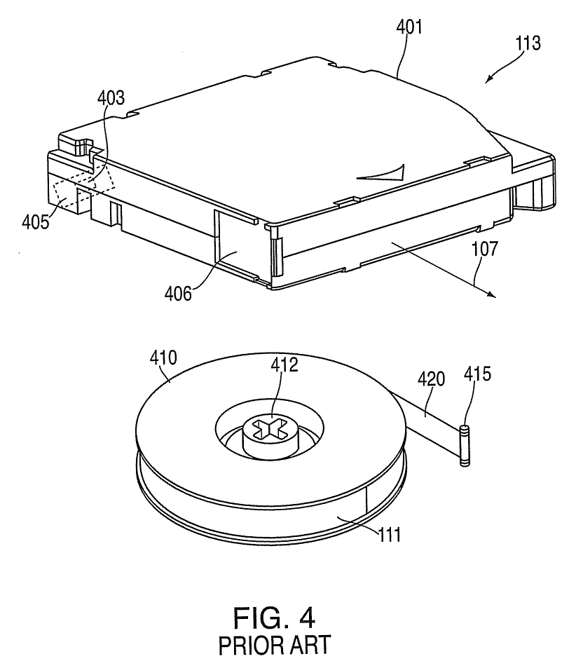

Combining this invention with partitioned tapes or other partitioned media also has special merit. FIG. 3 shows the concept of a partitioned tape 300. Partitioned tape 300 is based on a tape cartridge 113 and tape media 111 as shown in FIGS. 1, 2, and 4. This example assumes that the actual tape media 111 is pulled out of the housing of a tape cartridge 113 to visualize the partitions. Tape 300 is partitioned in two partitions 304 and 310. The first partition 304 is at the beginning of the tape 300 and starts with a partition initialization area 302. This initialization area contains unique indicators and identifiers for that partition and indicates the start of this partition. The end 306 of first partition 304 indicates the end of that partition. The first partition 304, located at the beginning of the tape media, allows fast access to data because it is at the beginning of the tape, and hence less time for locates (seeking to the data when tape cartridge 113 is first loaded) is needed.

The second partition 310 starts beyond the end of the first partition 306 with a partition initialization area 308 that has a similar purpose as partition initialization area 302. The second partition 310 ends with an ending area 312 that indicates the end of that second partition. The second partition 310 may have a larger capacity than the first partition 304 and is thus allowed to store a more data than first partition 304.

When combining multiple logical tape drives in one physical tape drive with partitioned tapes, each logical tape drive addressed via a unique LUN can be uniquely assigned to one partition on tape. Ultimately, this embodiment of our invention sets forth that the number of partitions on a physical tape is equal to the number of logical tape drives within one physical tape drive. I/O requests such as read and write operations to one logical tape drive (or LUN) are directed to one particular partition 304 or 310 of FIG. 3 on tape 111. In particular, the tape drive logic 105 recognizes an I/O request from a logical drive which identifies itself by the LUN number and positions the tape to the associated partition on tape. Subsequently all operations on tape such as read, write, and locate operations are performed on this partition. Tape drive operations according to this invention are described below. These operations are now described for logical tape drive 220 using tape partition 310.

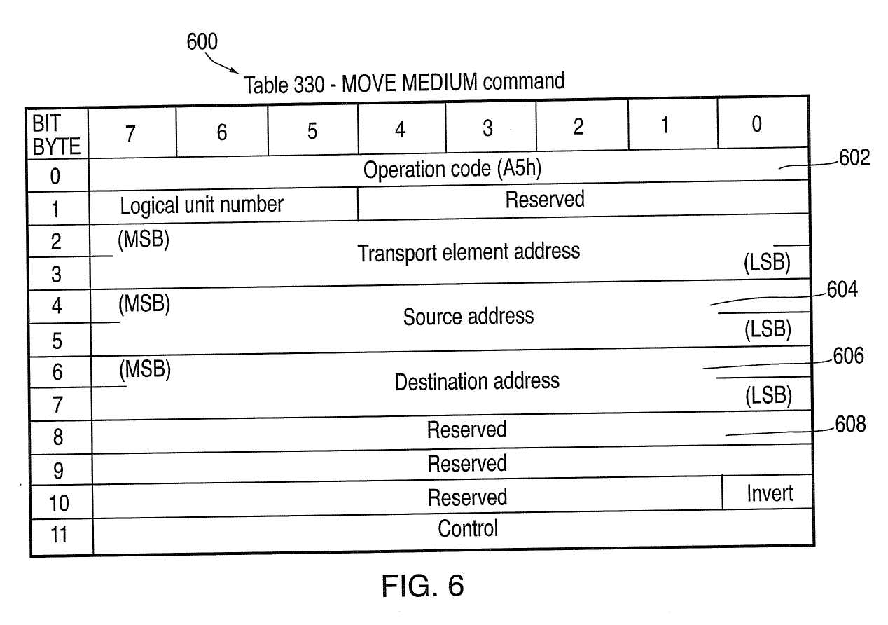

Mount Operation: Mount operation is based on a medium changer command, for example the MOVE MEDIUM command 600 according to the SCSI-3 Standard as shown in FIG. 6 with some modification as explained below. The MOVE MEDIUM command 600 is sent by a host system 130-132 to the logical tape drive 220. The command has an operation code of 0xA5h 602, where the suffix “h” denotes that operation code 602 is a hexadecimal number. The source address field 604 specifies the source slot of a tape cartridge 113 in the library. The destination address 606 specifies the slot address of the physical tape drive 201 hosting logical tape drive 220 which is subject to be mounted. Thus, the SCSI MOVE MEDIUM command is or may be modified. Reserved field 608 is used in this embodiment to specify the partition, such as partition 304 or 310, of the tape to be mounted in to the logical tape drive. The partition is specified in a hexadecimal value. Since partition 310 is the second partition on tape 300, field 608 includes the value 0x2h indicating the second partition. The first partition would have a value of 0x1h.

The host system issues a mount command such as the SCSI-3 MOVE MEDIUM command 600 to the logical tape drive 220.

The logical tape drive 220 receives the command via I/O interface 202 and passes it on the logical tape drive logic 210. Logical tape drive logic 210 passes the command on to physical tape drive logic 105 because it is a command for the library. The physical tape drive controller passes the command on to the library via library interface 115. The command instructs the library to mount the tape cartridge of the source address 604 into the physical tape drive with destination address 606, if it is not already mounted in the physical drive that belongs to the logical tape drive. If the physical tape cartridge is mounted already, the library just confirms that the tape is already mounted.

When the tape is mounted, then the logical tape drive logic 210 of logical tape drive 220 and the physical tape drive logic 105 associate the tape partition 310 given in field 608 of the move medium command 600 to the logical drive 220. The logical tape drive logic 210 of logical drive 220 now ensures that further incoming SCSI commands are handled within the associated tape partition. This way an association between the logical tape drive 220 and the mounted partition has been accomplished. This association is valid until the tape is dismounted from the logical tape drive (see dismount processing). For the further explanation, it is assumed as an example that the partition 310 is associated with logical tape drive 220.

Subsequent I/O requests are handled by the logical tape drive 220 for the associated partition 310.

In another embodiment, tape drive 201, and more particularly physical tape drive logic 105, includes a method to configure and assign logical tape drives based on the number of partitions of a tape 300 during mount processing. With this method an ordinary SCSI MOVE MEDIUM command is used as shown in FIG. 6 without the additional field 608. When a physical tape cartridge 113 is mounted in a tape drive 201 by the move medium command 600, the physical tape drive logic determines the number of partitions on partitioned tape 300 (FIG. 3). Based on that number, the physical tape drive logic generates and configures the corresponding number of logical tape drives, including an I/O interface address (LUN), buffer, and logical tape drive logic. Thus, for each partition on a partitioned tape, a logical tape drive is dynamically configured. Furthermore, the physical tape drive logic assigns the tape partitions to logical tape drives in a simple way, where the first partition on tape is assigned to the first logical tape drive, and so on. Subsequent tape operations are directed to the partition that is associated (assigned) to the logical tape drive receiving the tape operation command via its I/O interface.

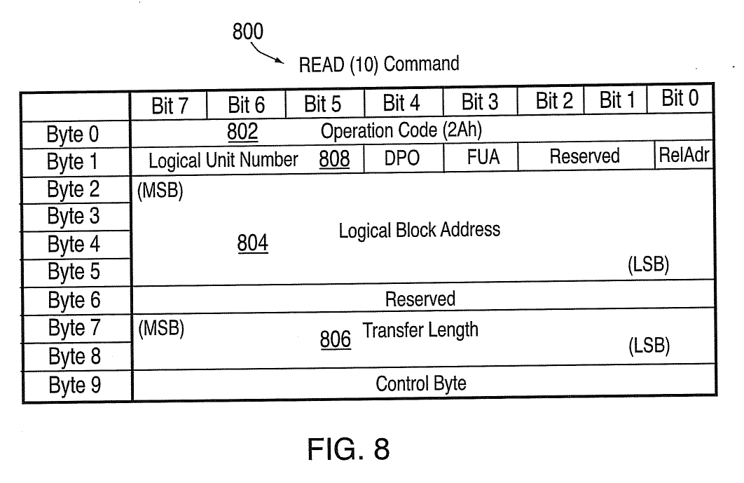

Read Operation: In this embodiment, read operation is based on a read command, for example the READ(10) command 800 according to the SCSI-3 Standard, as shown in FIG. 8. The READ(10) command 800 is sent by a host system 130-132 to the logical tape drive 220. The command has an operation code of 0x28h 802, where the suffix “h” denotes that the operation code 802 is a hexadecimal number. The logical block address field 804 specifies the starting block address for the read operation on the tape partition, such as partition 304 or 310. The field transfer length 806 specifies the number of bytes to be read by logical tape drive 220 from the tape partition, such as partition 304 or 310, based on the starting block address 804. It is Logical Unit Number 808 that determines which partition is being read.

The logical tape drive 220 receives the SCSI READ command 800 via I/O Interface 202 and passed it on the logical tape drive logic 210.

The logical tape drive logic 210 checks its buffer 206 whether the requested data is in the buffer.

If the requested data is in the buffer the logical tape drive logic sends the requested data to the requesting host system. If the requested data is not in the buffer the logical tape drive logic instructs the physical tape drive logic 105 to receive the data from tape.

The physical tape drive logic 105 operates the read-write head 106, and reel-motors 108 and 110, within the partition, such as partitions 304 or 310, of the tape associated with the logical tape drive 220, reads the data from tape 111, and transfers the data into the buffer 206 of the logical tape drive 220. If the buffer 206 does not offer enough capacity for the data the physical tape drive logic provides more buffer capacity based on the buffer management logic described later. Upon completion of the transfer, the physical tape drive logic informs the logical tape drive logic about the buffer location. If the read-write head 106 and reel-motors 108 and 110 are busy reading or writing data for another logical drive, such as 221 or 222, the physical tape drive logic will wait until this operation is finished before it initiates the requested operation by logical tape drive 220. Further methods for managing concurrent access to the physical tape drive components are described later.

The logical tape drive logic sends the requested data to the hosts system as a result of the read command. The read command is completed.

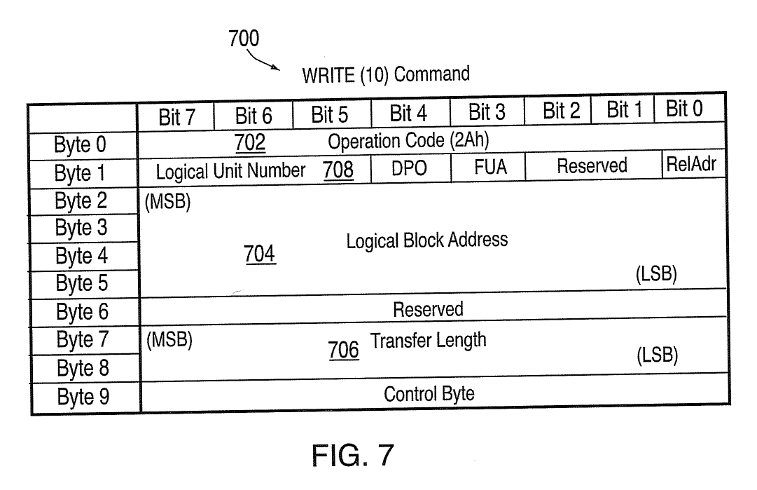

Write Operation: Write operation is based on a write command, for example the WRITE(10) command 700 according to the SCSI-3 Standard as shown in FIG. 7. The WRITE(10) command 700 is sent by a host system 130-132 to the logical tape drive 220. The command has an operation code of 0x2Ah 702, where the suffix “h” denotes that the operation code 702 is a hexadecimal number. The logical block address field 704 specifies the starting block address on the tape partition, such as partition 304 or 310, for the write operation. The field transfer length 706 specifies the number of bytes to be written by logical tape drive 220 from the tape partition 310 based on the starting block address 704. It is Logical Unit Number 708 that determines which partition is being written to.

The logical tape drive 220 receives the SCSI write command 700 and the data to be written from the host system via I/O Interface 202 and passes it on the logical tape drive logic 210.

The logical tape drive logic checks the available capacity in its buffer 206. If there is not enough available capacity the logical tape drive logic instructs the physical tape drive logic 105 to provide more buffer. The physical tape drive logic provides more buffer based on the buffer management logic described later.

The logical tape drive 220 transfers the data to the logical tape drive buffer 206 and sends a completion message for the write command to the host system.

At a later point of time, usually upon synchronization requests (see below), the data from the buffer 206 is written to the tape partition 310 associated with the logical tape drive 220. The association of tape partition and logical tape drive was done during mount processing.

Synchronization Operation: Synchronization operations are usually triggered by commands sent by the host system 130-132 which cause the content of buffer 206 of the logical tape drive 220 to be written to the associated tape partition, such as partition 304 or 310. Typical examples for such commands are rewind, unload and locate commands. Subsequently, these commands are called synchronization requests.

When the logical tape drive 220 receives a synchronization request from a host system, it checks its buffer 206 for data which must be written to tape partition, such as partition 304 or 310. If there is no data to be written to tape, the logical tape drive returns a completion message for the synchronization command. If there is data in the buffer to be written to the associated tape partition, the logical tape drive logic 210 instructs the physical tape drive logic 105 to write the data to a tape partition, such as partition 304 or 310. Thereby the logical tape drive logic gives a pointer of the data in its buffer to the physical tape drive logic.

The physical tape drive logic recognizes the tape partition based on the association made during mount processing and writes the data to the tape partition by operating and controlling the reel-motors (108 and 110) and read-write head 106. If the read-write head and reel-motors are busy reading or writing data for another logical drive, such as 221 or 222, the physical tape drive logic will wait until this operation is finished before it initiates the requested operation by logical tape drive 220. Further methods for managing concurrent access to the physical tape drive components are described later.

When all data has been written to the tape partition, the physical tape drive logic 105 informs the logical tape drive logic 210 about the completion. The logical tape drive logic sends a completion message as response to the synchronization request to the host system.

Upon reception of a successful synchronization with the physical tape partition, the logical tape drive logic clears the data from its buffer 206.

The physical tape drive performs the actual command underlying the synchronization request which can be rewind, unload, and locate commands and informs the logical tape drive of its completion. The logical tape drive informs the host system issuing the synchronization request about the completion.

Dismount Operation: Dismount operation is based on a medium changer command, for example the MOVE MEDIUM command 600 according to the SCSI-3 Standard as shown in FIG. 6. This is the same command used for the mount operation just with different parameter setting. The MOVE MEDIUM command 600 is sent by a host system 130-132 to the logical tape drive 220. The command has an operation code of 0xA5h 602, where the suffix “h” denotes that the operation code 602 is a hexadecimal number. The source address field 604 specifies the slot address of the physical tape drive 201 hosting the logical tape drive 220 to be dismounted. The destination address field 606 specifies the slot address for the tape cartridge 113 to be disposed in the library.

The host system issues a dismount command such as the SCSI-MOVE MEDIUM command 600 to a logical tape drive 220.

The logical tape drive 220 receives the command via I/O interface 202 and passes it on the logical tape drive logic 210. Logical tape drive logic 210 passes the command on to physical tape drive logic 105 because it is a command for the library.

The physical tape drive logic 105 checks whether any other logical tape drive, such as 221 or 222, has an association with a partition of the cartridge 113 mounted in the physical tape drive 201. If there is an association the physical tape drive controller sends a completion message to the logical tape drive logic 210. If there is no association, the physical tape drive logic 105 sends the dismount request to the library via library interface 115. The library dismounts the tape cartridge 113. The physical tape drive logic sends a completion message to the logical tape drive logic 210.

Upon reception of the dismount completion message the logical tape drive logic 210 sends the completion of the MOVE MEDIUM command 600 to the host system which issued the command.

The logical tape drive logic deletes the association between the logical drive 220 and the tape partition, such as partition 304 or 310. The physical tape drive logic 105 also deletes the association between the logical drive 220 and the tape partition, such as 304 or 310.

Next the handling of simultaneous access to physical tape according to at least an embodiment of this invention is described:

The physical tape drive 201 has one independent read/write channel and head 206 which does read and writes to the physical tape 111 and more particular to the appropriate tape partition (304 or 310). Multiple logical tape drives may request read or write access to the physical tape and more particular to the appropriate partition at the same time. The physical tape drive logic 105 manages the access to tape based on different policies. In the preferred embodiment, the policy can be set by the user as part of the tape drive configuration. In an alternate embodiment, the policy can also be set by the host system (130-132) using an appropriate command such as the SCSI-3 MODE SELECT command specifying a new (unused) modes page. Only one of the following policies can be active at a given time for the physical tape drive 201 including all logical tape drives 220-222.
1. Fairplay: each logical tape drive gets the same priority to access the physical tape. The first logical tape drive requesting access gets the access first.
2. Type of request: reads over write, where logical tape drives requesting read operations are preferred over logical tape drives requesting write operations. Read operations are often preferred over write operations, as write operations can be cached, but the user waits for the data to be read.
3. Type of application: Mission critical applications get preferred access. Mission critical applications identify themselves to the logical tape drive by a SCSI Mode Set Command. The mode set command includes a numeric parameter in a range between 0 and 5, where 5 denotes the most mission critical.

In addition it may occur that the physical tape is positioned at the end of the tape and the physical tape drive logical receives a write request by a logical tape drive to the beginning of the physical tape. Instead of locating the physical tape to the beginning, which takes some time, there is a reserved set of tracks on the physical tape allocated to store intermediate data. This reserved set of tracks may have a separate read/write channel. In the scenario above, the physical tape drive logic writes the data to the intermediate set of tracks, instead of locating the tape to the beginning. This saves valuable time. The physical tape drive logic 105 keeps track of the data written to the intermediate tracks and when the physical tape drive becomes less busy performing I/O operations, it will write the data into the actual partition. This is an extension of the existing nonvolatile cache known as recursive asynchronous backhitchless flush or RABF for the IBM 3592 tape drive.

Buffer management of the buffer 206, 207 and 208 of logical tape drives 220, 221 and 222 within physical tape drive 201 is done by the physical tape drive logic 105. Buffer management refers to the process of un-assigning part of the buffer from a logical tape drive which does not need it at a given time and assigning it to a logical tape drive requesting more buffer capacity. Buffer management is required when a logical tape drive does not have enough buffer during a write or read operation.

Physical tape drive logic 105 is able to obtain the amount of data and the logical tape drive state. This involves communication between the physical tape drive logic 105 and logical tape drive logics 210, 211 and 212. The amount of data is expressed in percent by:

Amount of data=(Amount of data in buffer/buffer capacity)*100

Amount of data in buffer is the capacity the data which needs to be written to a 4physical tape partition. Buffer capacity is the total capacity which is assigned to this logical tape drive.

The process of informing the physical tape drive logic can be that the physical tape drive logic polls all logical tape drive logic periodically. In an alternate embodiment, the physical tape drive logic queries these parameters from the logical tape drive logic when needed, i.e. when a logical tape drive logic requests more buffer for a write operation.

Logical drive state is determined by the logical tape drive logic. The following states are defined:
Idle: no association of logical tape drive and tape partition
Mounted/idle: association of logical tape with tape partition and no command is in progress
Mounted/read: association of logical tape with tape partition and read command is in progress
Mounted/write: association of logical tape with tape partition and write command is in progress
Mounted/synch: association of logical tape with tape partition and synchronization request is in progress
Mounted/Dismount: association of logical tape with tape partition and dismount request is in progress

The initial configuration after power up or reset is that each logical tape drive gets an equal buffer capacity. Thus the buffer capacity is for each logical tape drive is:

Total Buffer/number of logical drives

If a logical tape drive is in a write or read operation and requires more buffer it requests this from the physical tape drive logic 105. Based on the amount of data and the logical drive state the physical tape drive logic 105 can make decisions from which logical tape drive buffer is unassigned to be reassigned to a logical tape drive requesting it. The decision logic is:
For all logical drives except the requesting one obtain logical drive state and amount of data in buffer and for each drive perform the following checks:
   If logical drive state is Idle then un-assign U1 of its buffer and end.
   Else If logical drive state is Mounted/idle then un-assign U2% of its buffer and end.
   Else If logical drive state is Mounted/dismount mount then un-assign U1% of its buffer and end.
   Else if logical drive state is Mounted/sync AND amount of data<A2% then un-assign U4% of its buffer and end.
   Else if logical drive state is Mounted/read AND amount of data<A1% then un-assign U2% of its buffer and end
   Else if logical drive state is Mounted/write AND amount of data<A3% then un-assign U3% of its buffer and end
   Else issue a message to the user of the tape drive and ask him to order more memory AND write the data residing in the buffer of the requesting logical drive directly to the associated partition on tape (this may require to hold of further write commands issued to this tape drive until the buffer is cleared).

Un-assigning buffer also includes assigning the unassigned portion to the requesting logical tape drive. Threshold parameter U1, U2, U3 and U4 are user configurable parameters determining how much of the buffer for a given logical tape drive is unassigned. Thereby U1>U2>U3>U4 applies. For example U1=90, U2=50 U3=30 and U2=20.

Threshold parameter A1, A2 and A3 are user configurable parameters determining how much data there is in the buffer. Thereby A1>A2>A3 applies. For example A1=40, A2=30 A3=20 and U2=20.

Combining an external removable media management system such as IEEE 1244 for Removable Media Management, StorageTek ACLSL or IBM 3494 Library Controller with a tape library which assembles presented multiple logical tape drives in one physical tape drive with partitioned tapes has special merit. The external media management system can generate and assign a unique virtual VOLSER (Volume Serial Number) to each tape partition and present each tape partition to applications like an unpartitioned tape. In this way already existing applications can use the present invention without further modification. With the help of the present invention different partitions of a single physical tape cartridge can be assigned to different applications whereby the data of different applications resides on the same physical tape. Thereby the data of one application is not exposed to another application.

This assigning of partitions to multiple applications without exposing the data to each other application has special merit for sharing tapes across applications with different I/O characteristics. For instance a tape can be partitioned in a very fast access head, a fast access middle, and a high capacity, slow access tail. The system can assign each application the partition with the best matching access characteristics and thus help to save costs.

The removable-media 111 may comprise but is not limited to, magnetic tape, optical tape, magneto-optical disk, phase-change optical disk, DVD (Digital Versatile Disk), HD-DVD (High Definition DVD), Blu-Ray, UDO (Ultra-density Optical), Holographic media, flash-memory, or hard-disk-drive media.

The removable-media drive may comprise but is not limited to, magnetic tape drives, optical tape drives, magneto-optical disk drives, phase-change optical disk drives, DVD drives, HD-DVD drives, Blu-Ray drives, UDO drives, Holographic media drives, flash-memory drives, or hard-disk-drives. Therefore, when the phrase “tape drive” or similar language is used herein it can refer to any of the above technologies and not just magnetic tape.

One of ordinary skill in the art can appreciate that a computer or other client or server device can be deployed as part of a computer network, or in a distributed computing environment. In this regard, the methods and apparatus described above and/or claimed herein pertain to any computer system having any number of memory or storage units, and any number of applications and processes occurring across any number of storage units or volumes, which may be used in connection with the methods and apparatus described above and/or claimed herein. Thus, the same may apply to an environment with server computers and client computers deployed in a network environment or distributed computing environment, having remote or local storage. The methods and apparatus described above and/or claimed herein may also be applied to standalone computing devices, having programming language functionality, interpretation and execution capabilities for generating, receiving and transmitting information in connection with remote or local services.

The methods and apparatus described above and/or claimed herein is operational with numerous other general purpose or special purpose computing system environments or configurations. Examples of well known computing systems, environments, and/or configurations that may be suitable for use with the methods and apparatus described above and/or claimed herein include, but are not limited to, SANs, personal computers, server computers, hand-held or laptop devices, multiprocessor systems, microprocessor-based systems, network PCs, minicomputers, mainframe computers, distributed computing environments that include any of the above systems or devices.

The methods described above and/or claimed herein may be described in the general context of computer-executable instructions, such as program modules, being executed by a computer. Program modules typically include routines, programs, objects, components, data structures, etc. that perform particular tasks or implement particular abstract data types. Thus, the methods and apparatus described above and/or claimed herein may also be practiced in distributed computing environments such as between different units where tasks are performed by remote processing devices that are linked through a communications network or other data transmission medium. In a typical distributed computing environment, program modules and routines or data may be located in both local and remote computer storage media including memory storage devices. Distributed computing facilitates sharing of computer resources and services by direct exchange between computing devices and systems. These resources and services may include the exchange of information, cache storage, and disk storage for files. Distributed computing takes advantage of network connectivity, allowing clients to leverage their collective power to benefit the entire enterprise. In this regard, a variety of devices may have applications, objects or resources that may utilize the methods and apparatus described above and/or claimed herein.

Computer programs implementing the method described above will commonly be distributed to users on a distribution medium such as a CD-ROM. The program could be copied to a hard disk or a similar intermediate storage medium. When the programs are to be run, they will be loaded either from their distribution medium or their intermediate storage medium into the execution memory of the computer, thus configuring a computer to act in accordance with the methods and apparatus described above.

The term “computer-readable medium” encompasses all distribution and storage media, memory of a computer, and any other medium or device capable of storing for reading by a computer a computer program implementing the method described above.

Thus, the various techniques described herein may be implemented in connection with hardware or software or, where appropriate, with a combination of both. Thus, the methods and apparatus described above and/or claimed herein, or certain aspects or portions thereof, may take the form of program code or instructions embodied in tangible media, such as floppy diskettes, CD-ROMs, memory sticks, hard drives, or any other machine-readable storage medium, wherein, when the program code is loaded into and executed by a machine, such as a computer, the machine becomes an apparatus for practicing the methods and apparatus of described above and/or claimed herein. In the case of program code execution on programmable computers, the computing device will generally include a processor, a storage medium readable by the processor, which may include volatile and non-volatile memory and/or storage elements, at least one input device, and at least one output device. One or more programs that may utilize the techniques of the methods and apparatus described above and/or claimed herein, e.g., through the use of a data processing, may be implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus described above and/or claimed herein may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or a receiving machine having the signal processing capabilities as described in exemplary embodiments above becomes an apparatus for practicing the method described above and/or claimed herein. When implemented on a general-purpose processor, the program code combines with the processor to provide a unique apparatus that operates to invoke the functionality of the methods and apparatus described above and/or claimed herein. Further, any storage techniques used in connection with the methods and apparatus described above and/or claimed herein may also be a combination of hardware and software.

The operations and methods described herein may be capable of or configured to be or otherwise adapted to be performed in or by the disclosed or described structures.

While the methods and apparatus described above and/or claimed herein have been described in connection with the preferred embodiments and the figures, it is to be understood that other similar embodiments may be used or modifications and additions may be made to the described embodiment for performing the same function of the methods and apparatus described above and/or claimed herein without deviating therefrom. Furthermore, it should be emphasized that a variety of computer platforms, including handheld device operating systems and other application specific operating systems are contemplated, especially given the number of wireless networked devices in use.

While the description above refers to particular embodiments, it will be understood that many modifications may be made without departing from the spirit thereof. The accompanying claims are intended to cover such modifications as would fall within the true scope and spirit of the present invention.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A single physical drive apparatus for use with removable-media partitioned into sections with multiple host computers making conflicting I/O requests comprising:
a plurality of logical media drives located in the single physical drive apparatus for the removable-media partitioned into sections wherein each logical media drive comprises:
an I/O interface each having a unique device identifier;
a virtual buffer associated uniquely with each device identifier; and
an individual drive logic associated uniquely with each device identifier;
wherein the removable-media is structurally partitioned into sections and each partition is assigned to one of the plurality logical media drives wherein each logical media drive is structured so that it only may use a uniquely assigned partition on the removable-media partitioned into sections according to the device identifier;
a removable-media drive read and write head;
a synchronized parallel central drive logic structured to manage and coordinate with each individual drive logic for reading, writing, and access to the removable-media partitioned into sections, by the plurality of logical media drives in parallel in order to synchronize and manage conflicting I/O requests, and the synchronized parallel central drive logic is also structured to provide buffer management based on a state of the logical media drives and an amount of virtual buffer allocated to the logical media drives wherein the central drive logic manages the assignment of the buffer to the appropriate logical media drive.

2. The apparatus of claim 1 wherein at least two I/O interfaces and at least two logical media drives are included.

3. The apparatus of claim 1 wherein the I/O interfaces are virtual interfaces having a unique device identifier and being addressable by their device identifier over the same physical interface.

4. The apparatus of claim 1 wherein the I/O interfaces are distinct physical interfaces all located on the apparatus and all having a unique device identifier.

5. The apparatus of claim 1 the unique device identifier is an SCSI Logical Unit Number (LUN), an SCSI Target ID, or a Fibre Channel World Wide Port Name (WWPM).

6. The apparatus of claim 1, wherein said removable-media comprises magnetic tape, optical tape, magneto-optical disk, phase-change optical disk, DVD (Digital Versatile Disk), HD-DVD (High Definition DVD), Blu-Ray, UDO (Ultra-density Optical), Holographic media, flash-memory, or hard-disk-drive media; and
said single physical drive apparatus comprise magnetic tape drives, optical tape drives, magneto-optical disk drives, phase-change optical disk drives, DVD drives, HD-DVD drives, Blu-Ray drives, UDO drives, Holographic media drives, flash-memory drives, or hard-disk-drives.

7. The apparatus of claim 1, wherein said partitions could be fixed partitions comprising different physical layers of a multi-layer Blu-Ray, DVD, or HD-DVD disk, or a physical set of tracks in a tape cartridge from BOT (beginning of tape) to EOT (end of tape).

8. The apparatus of claim 1, wherein said partitions are variable partitions, comprising various lengths along a magnetic tape, or sections of flash memory.

9. A method for controlling a physical media drive apparatus for use with removable-media partitioned into sections and for use with multiple host computers making conflicting I/O requests comprising:
reading or writing different sets of data in parallel to or from the multiple host computers to a plurality of logical media drives comprising:
addressing a plurality of I/O interfaces each having a unique device identifier and located in the same physical media drive apparatus, wherein each logical media drive:
sends data through an I/O interface each having a unique device identifier;
stores the data in a virtual buffer associated uniquely with each device identifier; and
reads or writes the data via a media drive logic associated uniquely with each device identifier;
assigning partitions in the removable-media partitioned into sections wherein each partition is assigned to one of the plurality logical media drives so that each logical drive only may use a uniquely assigned partition on the removable-media partitioned into sections according to the device identifier; and
reading or writing the data to the removable-media partitioned into sections in the uniquely assigned partition on the removable-media partitioned into sections in parallel fashion according to the device identifier via a central drive logic located in the same physical media drive apparatus and structured to manage and coordinate with each of the media drive logics for reading, writing, and accessing the removable-media in parallel by the plurality of logical media drives; and
providing buffer management based on a state of the logical media drives and an amount of virtual buffer allocated to the logical media drives wherein the central drive logic manages the assignment of the buffer to the appropriate logical media drive.

10. The method of claim 9 wherein at least two I/O interfaces and at least two logical media drives are included.

11. The method of claim 9 wherein the I/O interfaces are virtual interfaces having a unique device identifier and being addressable by their device identifier over the same physical interface.

12. The method of claim 9 wherein the I/O interfaces are distinct physical interfaces all located on the physical media drive apparatus and all having a unique device identifier.

13. The method of claim 9, wherein said removable-media comprises magnetic tape, optical tape, magneto-optical disk, phase-change optical disk, DVD (Digital Versatile Disk), HD-DVD (High Definition DVD), Blu-Ray, UDO (Ultra-density Optical), Holographic media, flash-memory, or hard-disk-drive media; and
said logical media drives comprise magnetic tape drives, optical tape drives, magneto-optical disk drives, phase-change optical disk drives, DVD drives, HD-DVD drives, Blu-Ray drives, UDO drives, Holographic media drives, flash-memory drives, or hard-disk-drives.

14. The method of claim 9, wherein said partitions could be fixed partitions comprising different physical layers of a multi-layer Blu-Ray, DVD, or HD-DVD disk, or a physical set of tracks in a tape cartridge from BOT (beginning of tape) to EOT (end of tape).

15. The method of claim 9, wherein said partitions are variable partitions comprising various lengths along a magnetic tape, or sections of flash memory.

16. A computer program product for controlling a physical removable-media drive apparatus for use with multiple host computers making conflicting I/O requests, the computer program product comprising a storage medium readable by a processing circuit and storing instructions for execution by the processing circuit for facilitating a method comprising:
reading or writing different sets of data in parallel to or from the multiple host computers to a plurality of logical media drives comprising:
addressing a plurality of I/O interfaces each having a unique device identifier and located in the same physical removable-media drive, wherein each logical media drive:
sends data through an I/O interface each having a unique device identifier;
stores the data in a virtual buffer associated uniquely with each device identifier; and
reads or writes the data via a media drive logic associated uniquely with each device identifier;
partitioning a removable-media into sections wherein each partition is assigned to one of the plurality logical media drives so that each logical media drive only may use a uniquely assigned partition on the removable-media according to the device identifier; and
reading or writing the data to the removable-media in the uniquely assigned partition on the removable-media in parallel fashion according to the device identifier via a central media drive logic located in the same physical removable-media drive and structured to manage and coordinate with each of the media drive logics for reading, writing, and accessing the removable-media in parallel by the plurality of logical removable-media drives; and
providing buffer management based on a state of the logical media drives and an amount of virtual buffer allocated to the logical media drives wherein the central drive logic manages the assignment of the buffer to the appropriate logical media drive.

17. The method of claim 9 wherein if the amount of virtual buffer allocated to the logical media drives is exhausted, the user receives a message from the physical media drive apparatus informing the user of insufficient buffer space and asking to user to purchase more buffer memory to resolve the bottleneck.
